(19) United States
(12) Patent Application Publication
(10) Pub. No.: US 2025/0314399 A1
(43) Pub. Date: Oct. 9, 2025

(54) IMPROVEMENTS IN GEOTHERMAL ENERGY EXTRACTION

(71) Applicant: Ceraphi Energy Limited, Great Yarmouth (GB)

(72) Inventors: Karl FARROW, Costessey (GB); Gary WILLIAMS, Caister on Sea (GB)

(21) Appl. No.: 18/860,269

(22) PCT Filed: Apr. 28, 2023
(86) PCT No.: PCT/GB2023/051132

§ 371 Date: Oct. 25, 2024

(30) Foreign Application Priority Data
Apr. 28, 2022 (GB) 2206236.8

(51) Int. Cl. F24T 10/00; G09B 23/40

(52) U.S. Cl. CPC F24T 10/00; G09B 23/40; F24T 2201/00

(57) ABSTRACT

A process and/or simulation for providing one or more technical specifications of characteristics of a geothermal energy extraction apparatus for use with a well formed in the ground, the process comprising the steps of identifying one or more physical characteristics of the said well, modelling a plurality of output criteria according to a plurality of possible characteristics of a geothermal energy extraction apparatus and the said one or more physical characteristics of the said well, providing one or more technical specifications of characteristics of a geothermal energy extraction apparatus for use with said well.

### FIELD OF THE INVENTION

The present invention relates to the design of geothermal energy extraction and recovery systems.

### BACKGROUND TO THE INVENTION

Extracting useful energy from the ground is a known activity. Such extraction can generally take the form of transferring solar radiation from the upper surfaces of the ground via a ground source heat pump or by transferring geothermal energy from much deeper underground. Geothermal energy, as the skilled reader will know, generally arises from heat generated from the Earth's core from nuclear decay or tectonic activity.

Geothermal extraction arrangements often take the form of a doublet system, whereby a fluid is passed down a well (‘injector’), through a permeable reservoir passage and then up a second well (‘producer’). Having been passed through this arrangement the fluid has absorbed heat from the surrounding rocks etc. In such a doublet system, the said passage is generally formed of one or more existing pathways within the surrounding rock. Alternatively or in addition, the said passage could be deliberately constructed.

Geothermal extraction arrangements can also be based on a single well arrangement. Our co-pending application, published as WO 2022/058707, describes arrangements of geothermal extraction based on a single well arrangement and a single well arrangement with branches.

In this disclosure, the term well is used broadly to encompass single well arrangements, single well with branches arrangements as well as well systems having a doublet form or more complex form.

Innovation is active in this broad area. For example CN113420389 describes a design method for the open heat exchange inner tube pump chamber section of a geothermal well. US2015330179 describes a process for recommendation of potentially suitable types of pipe to select for an installation.

The present disclosure relates to a different inventive concept as set out below.

### SUMMARY OF INVENTION

Broadly, this invention disclosure provides a system and method for providing recommended parameters for geothermal energy capture installations. The invention is aimed at providing new geothermal energy capture installations for existing wells (for example for re-using wells which have been constructed in the past for different reasons, such as former hydrocarbon wells) and to wells which are yet to be constructed.

The wells in question are generally deep wells formed, as mentioned above, by drilling into the Earth's crust. The wells are generally not of the shallow kind intended for use with ground source heat pumps. The kinds of installations which the present invention can provide parameters for are envisaged to be primary energy sources which extract geothermal energy from the heat of rocks etc. below ground.

The kinds of installations which the present invention can provide parameters for are generally single bore closed loop systems, in which the heat exchange fluids do not interact with formation fluids in the well. However, the inventive concept can be applied to other well arrangements, including doublet systems. Throughout this disclosure, the term well can also refer to more than one well bore within a context.

Thus, the present invention provides a holistic system and accompanying methods for recommending parameters for complex apparatus based on external factors. Ideally, the present invention's output enables a whole-system design to be derived therefrom.

By complex we mean including several interacting components. For example only, such a complex apparatus might include pipes, pumps, heat exchangers, control systems, centralisers.

By external factors we mean attributes such as the depth of a well, the prevailing temperature and different points within a well, the location of the well relative to other elements (such as infrastructure, energy demand, the type of energy demand, other wells), and the like. As described above, the invention relates to applying geothermal energy extraction apparatus to existing wells, for example those which have been previously constructed for another purpose and to new wells/projects.

By type of energy demand we refer to the ways that energy can be distributed, such as via hot water, steam, electricity generation, and so on. The ultimate aim being to use the geothermal energy which might be available in the most effective way.

Thus, the present invention can provide recommended design parameters to maximise utility for a geothermal energy extraction project.

Thus, present invention provides a process for providing one or more technical specifications of characteristics of a geothermal energy extraction apparatus for use with a well formed in the ground, the process comprising the steps of identifying one or more physical characteristics of the said well, modelling a plurality of output criteria according to a plurality of possible characteristics of a geothermal energy extraction apparatus and the said one or more physical characteristics of the said well, providing one or more technical specifications of characteristics of a geothermal energy extraction apparatus for use with said well.

The said process may be applied to geothermal extraction apparatus for a newly-drilled well. The term well is used throughout this description as a general term; the skilled reader will appreciate that it includes terms such as bores and the like as well as more complex arrangements such as doublets, as set out above.

For a given one or more physical characteristics of the said well there may be more than one feasible technical specification. Such more than one feasible technical specifications may involve trade offs. For example, one plausible technical specification may be expected to be more straightforward to implement than another which may be expected to provide more geothermal energy over a longer period.

The process may include a step of providing a ranking of said one or more technical specifications according to user priorities.

Thus, the process provides an analytical model for providing one or more technical specifications of characteristics of a geothermal energy extraction apparatus.

The present invention may also provide a simulation to assess one or more technical specifications of characteristics of a geothermal energy extraction apparatus for use with a well formed in the ground, the simulation comprising the steps of identifying one or more physical characteristics of the said well, modelling a plurality of output criteria according to a plurality of possible characteristics of a geothermal energy extraction apparatus and the said one or more physical characteristics of the said well, providing one or more technical specifications of characteristics of a geothermal energy extraction apparatus for use with said well. The output of one or more technical specifications of characteristics of a geothermal energy extraction apparatus for use with said well can inform a user of potential options for proceeding with a physical installation.

The result of the invention is a design for project management of geothermal projects for their entire lifecycle. From identifying the feasibility and bankability of a project, to well construction, plant installation, operations and management and on to final decommissioning. It captures the external factors of a relevant site the energy needs of the user and outlines the process to deliver the same.

The said process and said simulation can stand independently or work in tandem. For example, the simulation can in some envisaged embodiments act as an additional modelling layer to the process as such.

The said one or more physical characteristics of the said well may be: the working fluid, the carrier fluid, the surrounding geology.

The present invention may provide a ranking of said one or more technical specifications according to user priorities.

The present invention may include an output calculator adapted to capture the well specific information (external factors) for each well, for example: the target depth (measure depth (MD) or true vertical depth (TVD)) and temperature at the bottom of the well. The invention can suggest the heat exchanger type and the tubular string diameters based on the selection of production casing/liner and subsequent heat-exchanger design.

The output may include the working fluid selection and can display the specific heat capacity and the fluid density thereof. The model can then estimate the thermal power available at the wellhead, change in temperature, the estimated annual heat production as a standalone well and with heat pump assistance. The user can also upload well diagrams for each well that is stored in a database.

The present invention may include calculations or simulation relating to the stimulation and/or enhancement of subsurface rock flow. The present invention may include calculations or simulation relating to the inclusion of heat recovery enhancement devices. Heat recovery enhancement devices may include convection enhancers, multilateral flow paths, stimulation techniques.

As described above, the present invention may include calculations or simulation relating to the location of the well relative to other elements (such as infrastructure, energy demand, the type of energy demand). In other words, depending on the location of the well relative to infrastructure (such as a connection to the broader high-voltage electricity grid) or energy demand, the most useful output is likely to vary. For example, if there is local demand for heat—for example for community heating projects—then the best output utility of a well may be to provide hot water without any conversion of the heat energy into another form. Alternatively, for example, if the well is physically isolated but near to a connection to the broader high-voltage electricity grid then the best output utility may be to convert heat energy from the well into electrical energy by way of turbines, such as Organic Rankine Cycle turbines. In other contexts, utility may be maximised by using the heat energy from the well to provide desalination of water, to electrolyse water for hydrogen production or other uses. The present invention may provide calculations or simulation of combinations of outputs: for example a mixture of electricity and hot water.

The present invention may include calculations or simulation relating to the arrangement of manifolding from the well. Such an arrangement may include other elements such as heat pumps.

The present invention may include calculations or simulation relating to potential heat losses due to the arrangement of different elements of the apparatus. The present invention may include calculations or simulation relating to potential energy costs (e.g. fuel) for other elements. These elements may, as described, include pumps, heat pumps, control systems and the like.

The present invention may include calculations or simulation relating to potential outputs and potential costs, so as to provide a range of technical specifications which a human user can then select from.

Thus, the present invention can provide calculations, models and simulations to demonstrate a combination of useful outputs for a particular well context based on resource availability and user priorities. For example, such a combination may include potential heated water flow rate and temperature, potential electricity output, potential surplus heat output, potential hydrogen via electrolysis. The calculations, models and simulations can thus help a user to decide how to develop a particular well context based on resource availability and needs. From one perspective, this provides for a reversal of a conventional decision making process in which development decisions are generally driven by demand needs—whereas the present invention can enable a decision based on the potential output of a well or more than one well. A combination of useful outputs may form an energy cascade wherein energy conversion devices are arranged in series with one another, with the aim of maximising useful outputs and energy efficiency.

### DETAILED DESCRIPTION OF THE INVENTION

In one aspect, the invention provides a vertically integrated analytic software platform design to enable fundable project delivery providing a cradle to grave project life cycle for the development of advanced geothermal projects. It is designed to confirm the feasibility and bankability of projects based on technical and commercial inputs and their associated risks to deliver an optimised bespoke solution. This is undertaken on a case by case basis for project delivery whilst managing technical and commercial risk through suitable mitigation.

The software allows the end user to undertake a staged development process through a set criteria of decision gates, starting with project scoping and evaluation to provide a solid business case for project investment sanction and financial investment decision (FID). Furthermore, it provides a basis of design from project process flow through to procurement, manufacturing, installation/commissioning, operation and maintenance management.
(Tier-1) calculation from front-end-user input data.
(Tier-2) defines initial input data.
(Tier-3) provides bankable business case and screens energy development options.
(Tier-4) provides options for manufacturing, equipment and delivery management solutions through to end of the production operational life.

The end user can access the front end where multiple inputs are entered clarifying various parameters either known or unknown starting with a standard data capture.

From these inputs algorithms generate key outputs determining energy offtakes in kilowatts of thermal power and/or kilowatts of electrical power which can be converted to kilograms of hydrogen or cubic metres of desalinated water establishing the scale of potential output of the required plant or facility. This in turn provides an economic overview and holistic model of the project. The output variables can be selected by the end user and may include but not be limited to CAPEX, OPEX, NPV, IRR, cost of finance, revenue and profit.

Finally, the system will provide a high level engineering basis for design for the desired project package along with determining the deliverables and interfaces for project management and completion of the project. This cover

s basic planning and schedule to the work packs and check sheets required through the construction and commissioning phase prior to operation and maintenance scheduling.

The system is arranged with a multi-tier approach. One tier may be a customer interface.

The customer interface may include input of general project and location data and any existing well and sub-surface information. The customer interface may include output to customer of a technical summary and/or financial summary, for example—which can also be tailored to suit the customer's needs and give a more detailed view of certain elements.

Another tier may be an internal interface. The internal interface may relate to matters including: subsurface evaluation; well design; drilling and workover programmes; surface infrastructure; process flow energy balance; economic evaluation and financing.

There are several modules that can be utilised in either individually or combined to enable the desired model and associated outputs to be delivered, these are outlined below:
Module 1—Repurposing well assets—providing the following guidance based on modelled outputs: —
Project planning instructions
Integrity planning instructions
Well repurposing outline plan
Recommended preferred vendors for well repurposing

A well information form can capture the name of the well site along with the coordinates. It allows the user to add details of the wells to be repurposed and select their type (which could be a producer, injector or unspecified.)
Module 2—New drilled geothermal systems—providing the following guidance based on modelled outputs: —
Project planning instructions
Well construction outline plan
Recommended surface infrastructure integrated with the closed loop system for well construction
Module 3—Surface Infrastructure Integration—providing recommendations of specifications and preferred vendors for the following processes based on modelled outputs: —
Power Generation
District Heating
Desalination
Electrolysis—Green Hydrogen Production
Agriculture/Aquaculture

Interactive plug-ins of each process can be included in the front-end to allow the end-user to determine their requirements form a high-level perspective. These show an overview of the energy balance of each individual process as well as giving a holistic visualisation of all process for the project with end-to-end energy flow/balance.

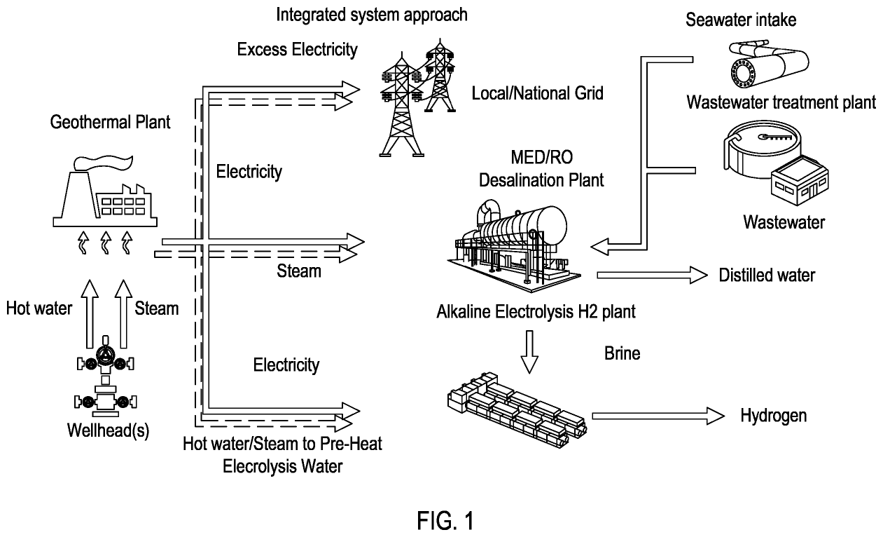

FIG. 1 shows how an exemplary resulting geothermal energy extraction apparatus might be integrated into an energy network.

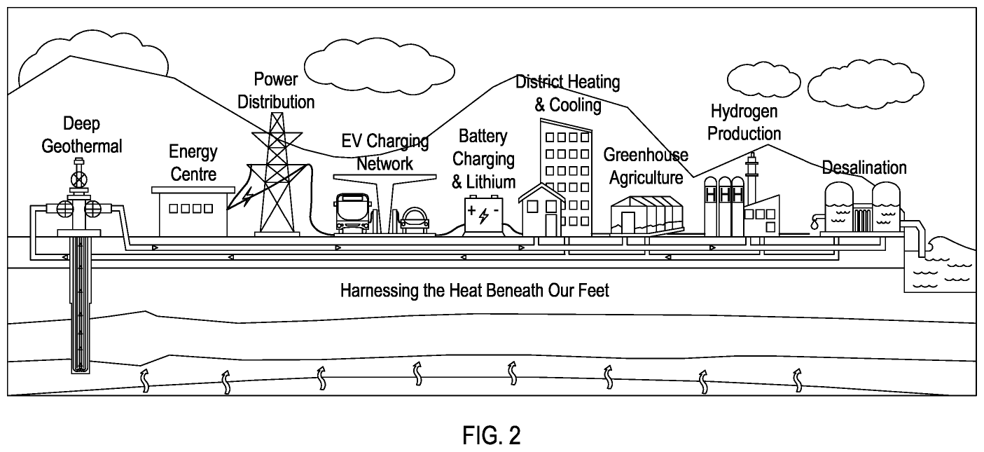

FIG. 2 shows an exemplary energy cascade, wherein a well output is connected first to an electricity generating apparatus (energy centre) which in turn is connected to other electrical demands via a electricity distribution network, the well output subsequently passes to a district heating and cooling installation, then to a greenhouse installation, then to a hydrogen production installation and finally to a water desalination installation. The supply of well output heat can be varied between these apparatus and installations over time according to energy demands and resource needs.

1. A process for providing one or more technical specifications of characteristics of a geothermal energy extraction apparatus for use with a well formed in the ground, the process comprising the steps of identifying one or more physical characteristics of the said well, modelling a plurality of output criteria according to a plurality of possible characteristics of a geothermal energy extraction apparatus and the said one or more physical characteristics of the said well, providing one or more technical specifications of characteristics of a geothermal energy extraction apparatus for use with said well, the process further comprising the step of calculating a stimulation and/or enhancement of subsurface rock flow.

2. A process according to claim 1, wherein the said one or more physical characteristics of the said well are selected from: the working fluid, the carrier fluid, the surrounding geology.

3. A process according to claim 1, further comprising the step of providing a ranking of said one or more technical specifications according to user priorities.

4. A process according to claim 1, further comprising an output calculator adapted to capture well specific information (external factors) for each well.

5. A process according to claim 1, further comprising the step of calculating an effect of including one or more heat recovery enhancement devices.

6. A process according to claim 1, further comprising the step of calculating an effect of an arrangement of manifolding from the well.

7. A process according to claim 1, further comprising the step of calculating potential heat losses due to the arrangement of different elements of the apparatus.

8. A process according to claim 1, further comprising the step of calculating potential energy costs required by other elements.

9. A simulation to assess one or more technical specifications of characteristics of a geothermal energy extraction apparatus for use with a well formed in the ground, the simulation comprising the steps of identifying one or more physical characteristics of the said well, modelling a plurality of output criteria according to a plurality of possible characteristics of a geothermal energy extraction apparatus and the said one or more physical characteristics of the said well, providing one or more technical specifications of characteristics of a geothermal energy extraction apparatus for use with said well, the simulation further comprising the step of simulating a stimulation and/or enhancement of subsurface rock flow.

10. A simulation according to claim 9, wherein the said one or more physical characteristics of the said well are selected from: the working fluid, the carrier fluid, the surrounding geology.

11. A simulation according to claim 9, further comprising the step of providing a ranking of said one or more technical specifications according to user priorities.

12. A simulation according to claim 9, further comprising an output simulator adapted to capture well specific information (external factors) for each well.

13. A simulation according to claim 9, further comprising the step of simulating an effect of including one or more heat recovery enhancement devices.

14. A simulation according to claim 9, further comprising the step of simulating an effect of an arrangement of manifolding from the well.

15. A simulation according to claim 9, further comprising the step of simulating potential heat losses due to the arrangement of different elements of the apparatus.

16. A simulation according to claim 9, further comprising the step of simulating potential energy costs required by other elements.

19. A process according to claim 1, further comprising a simulation to assess the one or more technical specifications of characteristics of the geothermal energy extraction apparatus, the simulation further comprising the step of simulating a stimulation and/or enhancement of subsurface rock flow.
